(19) United States
(12) Patent Application Publication
(10) Pub. No.: US 2017/0187656 A1
(43) Pub. Date: Jun. 29, 2017

(54) DYNAMIC CHANGE MANAGEMENT FOR CORRESPONDENCE TO ENABLE LIVE FILE ATTACHMENTS

(71) Applicant: INTERNATIONAL BUSINESS MACHINES CORPORATION, Armonk, NY (US)

(72) Inventors: PAUL BASTIDE, BOXFORD, MA (US); ANDREW E. DAVIS, ARLINGTON, MA (US); YUN ZHI LIN, BEIJING (CN)

(73) Assignee: International Business Machines Corporation, Armonk, NY (US)

(21) Appl. No.: 15/054,426

(22) Filed: Feb. 26, 2016

Related U.S. Application Data
(63) Continuation of application No. 14/982,173, filed on Dec. 29, 2015, now abandoned.

(51) Int. Cl. H04L 12/58; H04L 12/26; H04L 29/08; G06F 17/30; H04L 29/06

(52) U.S. Cl. CPC H04L 51/08; G06F 17/30589; H04L 65/403; H04L 67/06; H04L 67/10; H04L 51/32; H04L 43/106

(57) ABSTRACT

A text exchange correspondence conveyed within a computing system can be analyzed. The correspondence can be associated with a sending timestamp. The correspondence can be sent from a sender to a recipient in a social networking system. The correspondence can include a message body and a file attachment stored within a data store of a text exchange message server. The file attachment can be a copy of an original file stored within a different data store. File modification information about the original file stored in the different data store can be retrieved. The file modification information can be compared to the sending timestamp to assess a modification occurrence of the original file after the sending timestamp. An indication of the modification of the original file can be presented within a user interface, responsive to determining the modification occurrence of the original file after the sending timestamp, providing.

### CROSS-REFERENCE TO RELATED APPLICATIONS

This application is a Continuation of U.S. patent application Ser. No. 14/982,173, filed 29 Dec. 2015 (pending), which is incorporated herein in its entirety.

### BACKGROUND

The present invention relates to the field of correspondence enhancement and, more particularly, to dynamic updates for correspondence to enable live file attachments.

Mail clients and online social networks are the universal mechanisms that connect disparate people and information in logical and organized ways. This connectivity facilitates sharing and processing of information between the users. The most common mechanisms of sharing and processing information are the inbox, wall, activity stream, timeline, or profile. These mechanisms enable users to rapidly share information with others and gather information from other participants in the networks. Each user creates, reads, and responds to countless messages each day; and can often lose track of current messages and files associated with the messages.

In many instances, users often collaborate on shared files for presentations, software development, and other business related endeavors. For example, when developing a software application, a team of users can often share project files such as source code files, meeting note files, and project management task files (e.g., requirements analysis). It is common for users to attach these files within correspondence such as emails or instant messages. Frequently, users edit out of date versions of the shared files as a result of a participant updating the file without alerting other participants of a change. Consequently, users are forced to consolidate old and new changes into a current file to merge the changes cohesively. This can often take a tremendous time and effort when large changes have been made independently. As such, a better mechanism for change management is needed.

### BRIEF SUMMARY

One aspect of the present invention can include a system, a computer program product, and a method for dynamic change management for correspondence to enable live file attachments. A text exchange correspondence conveyed within a computing system can be analyzed. The correspondence can be associated with a sending timestamp. The correspondence can be sent from a sender to a recipient in a social networking system. The correspondence can include a message body and a file attachment stored within a data store of a text exchange message server. The file attachment can be a copy of an original file stored within a different data store. File modification information about the original file stored in the different data store can be retrieved. The file modification information can be compared to the sending timestamp to assess a modification occurrence of the original file after the sending timestamp. An indication of the modification of the original file can be presented within a user interface, responsive to determining the modification occurrence of the original file after the sending timestamp, providing.

Another aspect of the present invention can include a method, a computer program product, and a system, for dynamic change management for correspondence to enable live file attachments. A collaboration engine can be configured to present a change associated with a file attachment of a text exchange message when an original file is modified after the file attachment is linked to the text exchange message. The original file can be the source of the file attachment during a file attachment process of a text exchange message. A data store can persist the text exchange message, the file attachment, and/or the original file.

Yet another aspect of the present invention can include a system, a computer program product, and a method for dynamic change management for correspondence to enable live file attachments. A text exchange message within a messaging server can be identified. The text exchange message can include a set of recipients, a sender, a transmission timestamp, a message body, a file attachment, and a file modification timestamp, wherein the file attachment is a computer file. The file attachment is modified by at least one of the set of recipients, automatically generating change data associated with the file attachment.

### BRIEF DESCRIPTION OF THE SEVERAL VIEWS OF THE DRAWINGS

FIG. 1 is a schematic diagram illustrating a scenario for dynamic change management for correspondence to enable live file attachments in accordance with an embodiment of the inventive arrangements disclosed herein.

FIG. 2 is a schematic diagram illustrating a method for dynamic change management for correspondence to enable live file attachments in accordance with an embodiment of the inventive arrangements disclosed herein.

FIG. 3 is a schematic diagram illustrating a system for dynamic change management for correspondence to enable live file attachments in accordance with an embodiment of the inventive arrangements disclosed herein.

### DETAILED DESCRIPTION

The present disclosure is a solution for dynamic change management for correspondence to enable live file attachments. In the solution, a user interface can present a digital correspondence such as an email, Short Message Service (SMS) message, and/or text exchange message (e.g., instant message). The correspondence can include but is not limited to, a message body, a file attachment, a file reference, and the like. In one instance, the file attachment can be a copy of an original file stored with a shared repository or non-shared repository (e.g., user's hard drive). In the instance, when the original file is modified, the user interface can be updated to present changes associated with the original file, which occurred after the creation of the copy. In one embodiment, the interface can present one or more options for viewing the original file, the current file (e.g., original file with changes), or a difference file with changes between the original file and the current.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

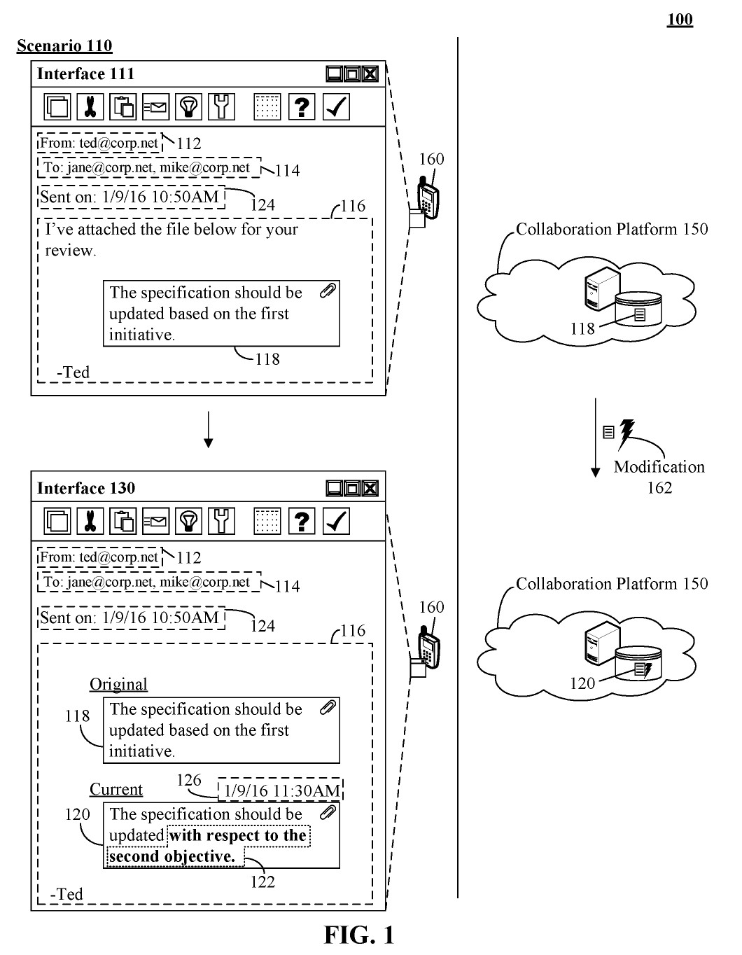

FIG. 1 is a schematic diagram illustrating a scenario 110 for dynamic change management for correspondence to enable live file attachments in accordance with an embodiment of the inventive arrangements disclosed herein. Scenario 110 can be performed in the context of method 200 and/or system 300. It should be appreciated that scenario 110 can be performed in the context of a social networking platform, a distributed computing environment, networked computing environment, and the like. In scenario 110, a text exchange messaging interface 111, 130 can be presented within a computing device 160. For example, interface 111, 130 can be an email client interface for reading, composing, and managing email.

Text exchange message can be a discrete data set of a text exchange session. Text exchange session can be a semi-permanent information exchange between computing devices. A text exchange message 116 can be a text-based message able to be communicated in real-time or near real-time. For example, text exchange message 116 can be an instant message associated with an instant message client (e.g., interface 111, 130) executing on a mobile phone 160. A text exchange message client can be an application executing on a computing device (e.g., 160) permitting text exchange messages to be composed and/or communicated. For example, an instant message client can be an IBM Sametime client. It should be appreciated within the scenario that client 160 can communicate with different computing devices (not shown). In one instance, a text exchange correspondence can include a set of text exchange messages within a text exchange session (e.g., activity stream, LinkedIn wall post. In another instance, text exchange correspondence can include a single text exchange message.

In one embodiment, message 116 can include a file attachment 118 such as a document and/or media file. In the embodiment, attachment 118 can include a computer file, a file reference (e.g., pointer), and the like. For example, attachment 118 can be a URL to a shared file stored in a social media data store. It should be appreciated that attachment can include metadata including, but not limited to, modification timestamp, a file reference, and the like. For example, attachment 118 can be associated with metadata, which include a URI indicating an original file from which the attachment was created.

In one embodiment, when an original file stored within a data store is attached to a message, a copy of the original file can be created and persisted within the message body in compliance with Multipurpose Internet Mail Extensions (MIME) standards. It should be appreciated that the original file and attachment can conform to a document, a media file, and the like. For example, attachment 118 can be a video file stored within an email server upon transmission of the message. As used herein, MIME can be an Internet standard that extends the format of email to support, text in character sets other than ASCII, non-text attachments (e.g., audio, video, images, application programs), message bodies with multiple parts, header information in non-ASCII character sets, and the like. MIME can include, but is not limited to, MIME headers (e.g., version information, content type, etc), multi-part messages, and the like.

It should be appreciated that the disclosure can leverage traditional and/or proprietary protocols to enable the functionality described herein. Protocols can include, but is not limited to, Simple Mail Transfer Protocol (SMTP), Post Office Protocol 3 (POP3), Internet Message Access Protocol (IMAP), Hypertext Transport Protocol (HTTP), Web Distributed Authoring and Versioning (WebDAV) protocol, and the like. In one instance, collaboration platform 150 can be communicatively linked with data havens, cloud based storage, and the like. For example, platform 150 can be communicatively linked to Google Drive or Dropbox to permit an original file to be stored within the cloud-based storage.

In scenario 110, a set of interfaces 111, 130 can present a file attachment 118 within a message 116. Message 116 can include a sender 112 and a set of recipients 114. For example, an email to a software development team can be send from a team leader (e.g., ted@corp.net) to team members (e.g., jane@corp.net, mike@corp.net) which can include a requirements analysis Microsoft Word document. Message 116 can include a timestamp which can indicate the date and/or time of transmission of the message 116 (and accompanying attachment 374).

In one embodiment, message 116 can be conveyed within a collaboration platform 150 (e.g., via an email server). In one configuration of the embodiment, attachment 118 can be stored within collaboration platform 150 within a shared file management system. For example, attachment 118 can be stored within a social network enabled email server, which can permit users within a social network to perform modifications 162 to attachment 118. In one embodiment of the disclosure, when attachment 118 is modified after message 116 is conveyed to recipients (e.g., difference between timestamp 124, 126), interface 130 can be utilized to present relevant change information. In the embodiment, interface 130 can present a current version 120 (e.g., based on message timestamp 124 and file modification timestamp 126) of attachment 118. In one instance, a notification can be presented to indicate a newer version of attachment is available 118. In the instance, an interface dialog can prompt a user to view changes 122 or ignore changes 122.

A use case below illustrates one implementation of the disclosure:

A user can compose an email to one or more recipients and attach a file to the email. The file attachment process can include selecting an original file, which can be copied during email transmission. When the attachment is added to the message, metadata can be added to the email message to indicate the original file path and name (e.g., file reference to the original file). During email transmission, the message body and the file attachment can be conveyed to an email server. The email server can convey the email to the recipients. When an email recipient modifies the attachment, change data can be generated for the attachment. In one instance, the change data can be generated by an email client or by the email server. It should be appreciated that the change data generation can be an optional functionality. In one instance of the use case, when a user reads the email, the email client can analyze the attachment (and original file via file reference) to determine change has occurred. In another instance of the use case, when a user reads the email, the email client can compare the transmission timestamp of the email with the original file timestamp to determine if the attachment has been modified. In the use case, an interface of the email client can present a notification to view the attachment, original file (with modifications), and/or changes between the attachment and the original file. It should be understood that interface can present notifications including, but not limited to, visual alerts, aural alerts, and the like. In one instance of the use case, an interface of the email client can present a pop-up dialog indicating a new version of an attachment is available and prompt the user to download the new version of the attachment.

Drawings presented herein are for illustrative purposes only and should not be construed to limit the invention in any regard. In one embodiment, the interface 111, 130 can be an interface of a text exchange client including, but not limited to, an IBM Sametime, a Web application communicatively linked to an IBM Verse, and the like.

In one embodiment of the disclosure, message 116 attachment 118 can be a file reference to a file within a file management application. In the embodiment, attachment 118 can be presented when the message 116 is displayed. Utilizing message 116 transmission timestamp, the version of the attachment 118 which can be presented can be easily updated. In one instance, a file change management functionality (e.g., of an online file management application) can store message metadata to link a message with a version of an attachment, which was originally conveyed. In the instance, when the file referenced by the attachment is changed, the stored message metadata can be analyzed to determine whether to present a change notification (e.g., notification 122) based on the message transmission timestamp and the file modification timestamp.

In one instance, message 116 can be associated with metadata including, but not limited to, transmission timestamp, read timestamp, flags (e.g., priority, read, starred), and the like.

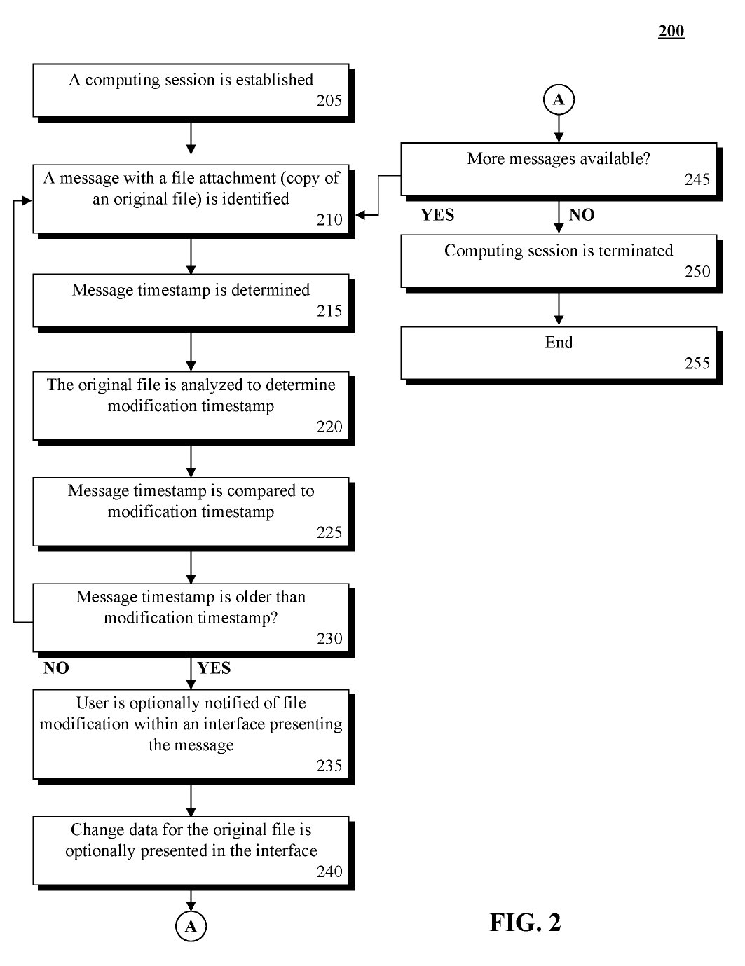

FIG. 2 is a schematic diagram illustrating a method 200 for dynamic change management for correspondence to enable live file attachments in accordance with an embodiment of the inventive arrangements disclosed herein. Method 200 can be performed in the context of scenario 110 and/or system 300. In one instance, method 200 can be performed in real-time or near real-time. In one embodiment, method 200 steps 205-255 can be performed in serial and/or in parallel. In one instance, steps 210-245 can be continuously performed for the duration of the session. For example, steps 210-245 can be a functionality of a change watch process thread within an email server.

In step 205, a computing session is established. For example, the computing session can be a process thread executing within a messaging server. In step 210, a message with a file attachment (e.g., copy of an original file) is identified. In step 215, a message timestamp is determined. Message timestamp can be determined utilizing one more traditional and/or proprietary mechanisms. In step 220, the original file can be analyzed to determine a modification timestamp. In step 225, message timestamp is compared to the modification timestamp. In step 230, if the message timestamp is older than the modification timestamp, the method can continue to step 235, else proceed to step 210. In step 235, a user can be optionally notified of the file modification within an interface presenting the message. In step 240, change data for the original file can be optionally presented within the interface. In step 245, if more messages are available, the method can return to step 210, else continue to step 250. In step 250, the computing session can be terminated. In step 255, the method can end.

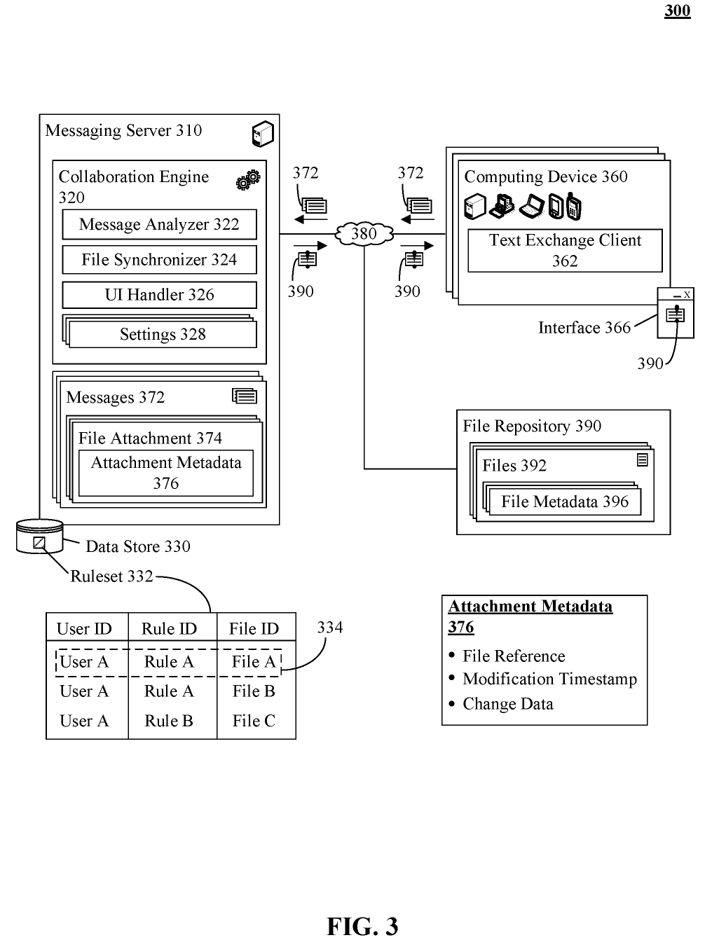

FIG. 3 is a schematic diagram illustrating a system 300 for dynamic change management for correspondence to enable live file attachments in accordance with an embodiment of the inventive arrangements disclosed herein. System 300 can be performed in the context of scenario 110 and/or method 200. In system 300, a collaboration engine 320 executing within a messaging server 310 can provide a live file attachment within a text exchange message 372. In one embodiment of the system 300, changes performed on files 392 linked to attachment 374 can be dynamically updated. It should be appreciated that attachment 374 can be stored within a different data store than that of file 392. Engine 320 functionality can be a functionality of a text exchange messaging server, a file collaboration platform, and the like.

Server 310 can be a hardware/software entity for communicating and/or storing text exchange messages 372. Server 310 can include, but is not limited to, a collaboration engine 320, messages 372, data store 330, and the like. Server 310 can include, but is not limited to, an email server, an instant message server, a Short Message Service (SMS) gateway, and the like. Server 310 functionality can include, but is not limited to, load balancing, file sharing, encryption, and the like.

Collaboration engine 320 can be a hardware/software element for enabling a live file attachment 372 within message 372. Engine 320 functionality can include, but is not limited to, message 372 transmission, message 372 storage, and the like. Engine 320 can include, but is not limited to, message analyzer 322, file synchronizer 324, user interface (UI) handler 326, settings 328, and the like. In one instance, engine 320 functionality can be a capability of an Application Programming Interface (API). In another instance, engine 320 functionality can be encapsulated within a Web-based service. It should be appreciated that engine 320 can enable a synchronous message scheme within an asynchronous framework (e.g., email). That is, although text exchange messaging occurs within an asynchronous architecture, engine 320 can provide synchronicity for file attachments without affecting architecture functionality. It should be appreciated that engine 320 can be arbitrarily complex and is not limited to the exact arrangements described herein.

Message analyzer 322 can be a hardware/software entity for processing messages 372. In one instance, analyzer 322 can determine the presence or absence of a file attachment 374. In the instance, when a file attachment 374 is present, metadata 376 can be generated and/or collected to enable the functionality described herein. In one embodiment, analyzer 322 can determine the semantic context of message 372 to intelligently notify a user of changes to files 392 and/or related attachment 374. In one embodiment, analyzer 322 can utilize traditional and/or proprietary semantic analysis techniques including, but not limited to, linguistic analysis (e.g., keyword detection), metadata analysis, and the like.

File synchronizer 324 can be a hardware/software element for linking attachment 374 to file 392 and/or establishing change data associated with attachment 374, file 392. In one embodiment, synchronizer 324 can collect file metadata 396 during message 372 creation and/or attachment 374 establishment. In the embodiment, file 392 information and/or metadata 396 can be persisted within attachment metadata 376. It should be understood that synchronizer 324 can utilize traditional and/or proprietary change management functionalities, including, but not limited to, difference data comparison, revision control capabilities (e.g., versioning metadata), and the like. In one embodiment, synchronizer 324 can present a summary of changes between a file attachment and a file. In another embodiment, synchronizer 324 can present participant information which can indicate which participants performed changes and when the changes were performed.

User interface (UI) handler 326 can be a hardware/software entity for enabling change notification within a user interface (e.g., interface 366). Handler 326 functionality can include, but is not limited to, UI presentation, input validation, and the like. In one embodiment, handler 322 can present a notification when file 392 timestamp is newer than message 372 timestamp. In the embodiment, notification can be automatically presented upon message receipt, message presentation, message archival, message forward, and the like.

Settings 328 can be one or more rulesets for establishing the behavior of server 310, engine 320, and/or system 300. Settings 328 can include, but is not limited to, analyzer 322 options, synchronizer 324 settings, handler 326 options, and the like. In one instance, settings 328 can include, security policy options, file 392 synchronization options, and the like. In one instance, ruleset 332 can be utilized to establish user specific rules for attachment 374. For example, a rule 334 of ruleset 332 can permit a user (e.g., User A) to ignore changes to file 392 (e.g., File A) when the timestamp difference between the file 392 and message 374 is less than five hours. Setting 328 can be manually and/or automatically determined. In one instance, setting 328 can be configured via interface 366.

Data store 330 can be a hardware/software component able to persist settings 328, ruleset 332, messages 372, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Computing device 360 can be a hardware/software permitting presentation of messages 372 and/or notification 390 via interface 366. Device 360 can include, but is not limited to, text exchange client 362, input/output components, user settings, microphone, camera, interface 366, and the like. Text exchange client 362 can include, but is not limited to, an email Web application, an email desktop application, a mobile phone email application, an SMS messaging application, a VOIP conferencing application, and the like. I/O components can include, but is not limited to, a camera, a keyboard, a mouse, an accelerometer, a biometric sensor, and the like. Computing device 360 can include, but is not limited to, a desktop computer, a laptop computer, a tablet computing device, a personal digital assistant (PDA), a mobile phone, and the like. Interface 366 capabilities can include a graphical user interface (GUI), voice user interface (VUI), mixed-mode interface, and the like. In one instance, interface 366 can be communicatively linked to computing device 360.

In one instance, notification 390 can be a user interface alert for indicating change occurrence within a file attachment 374 of a text exchange message 372. Notification 390 can include, but is not limited to, an alert message, a user triggered programmatic action (e.g., update attachment, ignore changes), and the like. In one embodiment, notification 390 can be utilized to show a score (e.g., percentage, numerical) associated with the difference between the file attachment 374 and the file 392. For example, notification 390 can show a score of 85% when file 392 has been heavily modified since message 372 was sent by the sender. It should be appreciated that notification 390 can be arbitrarily complex and is not limited to the exact arrangements described herein.

File repository 390 can be a hardware/software entity able to persist files 392. In one instance, repository 390 can be a shared file storage repository including, but not limited to, a cloud based storage, a local area network accessible storage, and the like. For example, repository 390 can be a corporate NAS accessible by team members of a product engineering group. In one instance, repository 390 can include, but is not limited to, files 392, settings, and the like. Files 392 can be associated with file metadata 396 (e.g., timestamp, author, etc), companion files, and the like.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), Virtual Private Network (VPN) and the like.

Drawings presented herein are for illustrative purposes only and should not be construed to limit the invention in any regard. It should be appreciated that one or more components within system 300 can be optional components permitting that the disclosure functionality be retained. It should be understood that engine 320 components can be optional components providing that engine 320 functionality is maintained. It should be appreciated that one or more components of engine 320 can be combined and/or separated based on functionality, usage, and the like. System 300 can conform to a Service Oriented Architecture (SOA), Representational State Transfer (REST) architecture, and the like.

In one instance, the disclosure can utilize traditional email metadata to tag “old” attachments for which change notifications can be presented when the email is read. That is, the disclosure can be easily integrated into existing text exchange (e.g., email, SMS) infrastructures which are extensively utilized. It should be appreciated that the disclosure can function within push transmission framework, a pull transmission framework, and the like.

As used herein, file synchronization can be a process of ensuring that computer files (e.g., file 392, attachment 374) in two or more locations (e.g., server 310, repository 390) are updated via certain rules (e.g., ruleset 332). Synchronization can include one-way file synchronization (e.g., mirroring) in which updated files are copied from a source location (e.g., file 392) to one or more target locations (e.g., message 372 attachment 374), but no files are copied back to the source location. In two-way file synchronization, updated files are copied in both directions, usually with the purpose of keeping the two locations identical to each other.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for indicating a change to file referenced in a message comprising:
analyzing a text exchange correspondence conveyed within a computing system, wherein the correspondence is associated with a sending timestamp, wherein the correspondence is sent from a sender to a recipient in a social networking system, wherein the correspondence comprises of a message body and a file attachment stored within a data store communicatively linked to a text exchange message server, wherein the file attachment is a copy of an original file stored within a different data store;
retrieving file modification information about the original file stored in the different data store;
comparing the file modification information to the sending timestamp to assess a modification occurrence of the original file after the sending timestamp; and
responsive to determining the modification occurrence of the original file after the sending timestamp, providing a new message to the original recipients of the original file, wherein the new message comprises an automatically created portion showing a portion of the original file that was modified, the original file as an attachment, an indication of the modification corresponding to the shown portion of the original file that visually shows the modification occurrence in context along with an attachment for a modified version of the original file per the modification occurrence.
